(19) United States
(12) Patent Application Publication
(10) Pub. No.: US 2015/0202750 A1
(43) Pub. Date: Jul. 23, 2015

(54) TWIN HAMMER CLUTCH IMPACT WRENCH

(71) Applicant: SP Air Kabushiki Kaisha, Nagano (JP)

(72) Inventor: Shigeki Kobayashi, Nagano (JP)

(73) Assignee: SP Air Kabushiki Kaisha, Nagano (JP)

(21) Appl. No.: 14/161,065

(22) Filed: Jan. 22, 2014

(51) Int. Cl. B25B 21/02; B25B 21/00

(52) U.S. Cl. CPC B25B 21/02; B25B 21/004

(57) ABSTRACT

A power driven tool for rotating a mechanical element. The tool includes a housing and motor. The motor has an output shaft. The shaft rotates relative to the housing. The tool also includes an impact drive axially fixed within the housing. The impact drive includes a base and an anvil shaft having an anvil. The impact drive includes annular hammers, each having opposite impact lands pivotally mounted on the base for movement between three positions, including a forward position in which the hammer is positioned so one impact land engages the anvil, a reverse position in which the hammer is positioned so another of the impact lands engages the anvil, and a disengaged position in which neither of the impact lands engages the anvil. Further, the tool includes a ratchet mechanism. The ratchet mechanism includes an output drive mounted for rotation relative to the housing for rotating a mechanical element.

### BACKGROUND OF THE INVENTION

This invention relates generally to power driven tools, and more specifically, it relates to a power driven tool for tightening or loosening fasteners having an impact drive with a twin hammer clutch.

Power driven tools for tightening or loosening fasteners (e.g., nuts and bolts) are known, and power driven tools incorporating impact drives that can intermittently provide an increased amount of torque for tightening or loosening fasteners are common.

An impact wrench incorporating a ratchet head is disclosed in co-owned U.S. Pat. No. 4,821,611 (Izumisawa). A pneumatic motor rotates a clutch case that coaxially houses an impact drive. Under normal operation, a cam ball fixed within the clutch case engages a finger of an impact clutch and rotates the clutch simultaneously with an output shaft for tightening or loosening the fastener. But when frictional resistance of the fastener exceeds the normal torque output of the tool, the cam ball slides under the impact clutch finger and pushes the clutch axially forward along the output shaft. This simultaneously moves a pair of hammers forward into registration with a corresponding pair of anvils of the output shaft. The hammers instantaneously impact the anvils and produce an increased amount of torque in the output shaft for overcoming the frictional resistance of the fastener. Immediately following the impact, the hammers retreat axially rearward and when the cam ball makes one full rotation with the clutch case, the impact process repeats.

However, the clutch case and cam ball generally move at a rate equal to the output speed of the motor, which is very high for pneumatic motors. Therefore when the output shaft is unable to turn the fastener, the cam ball repeatedly pushes the impact clutch and hammers axially forward at a similar rate. This often occurs so rapidly that the hammers impact the anvils before corresponding surfaces fully register, or alternatively the hammers completely miss the anvils and fail to produce any additional torque. Moreover, when the frictional resistance of the fastener exceeds the additional torque produced by the hammers, the cam ball, and impact clutch may unnecessarily push the hammers into repeated registration with the anvils before an operator can disengage the motor. This can be hard on components of the impact drive (e.g., the cam ball and impact clutch) and may damage them or prematurely wear them out before other components of the wrench.

Co-owned U.S. Pat. No. 7,080,578 (Izumisawa) incorporates a speed reducing mechanism in the power driven impact wrench. This particular design reduces the speed of the motor output and controls the impact rate of the hammers of the impact drive. While the components of the impact drive are less prone to damage and wear, the speed reducing mechanism requires the use of additional components which add complexity to the tool.

Accordingly, there is a need for a power driven ratchet tool having an impact drive capable of providing adequate damage and wear protection without using a speed reducing mechanism.

### SUMMARY OF THE INVENTION

This invention relates generally to a power driven tool for rotating a mechanical element. In one aspect, the tool comprises a housing and a motor positioned in the housing having an output shaft extending therefrom. The shaft rotates relative to the housing during motor operation. In addition, the tool has an impact drive axially fixed within the housing and operatively connected to the motor output shaft. The impact drive includes a base, an anvil shaft having an anvil extending therefrom rotatably mounted on the base, and a plurality of annular hammers. Each hammer has opposite impact lands pivotally mounted on the base for movement between three positions, including a forward position in which the respective hammer is positioned so one of said impact lands engages the anvil, a reverse position in which the respective hammer is positioned so another of said impact lands engages the anvil, and a disengaged position in which neither of the impact lands engages the anvil. The tool also includes a ratchet mechanism operatively connected to the anvil shaft of the impact mechanism. The ratchet mechanism includes an output drive mounted for rotation relative to the housing for rotating a mechanical element in a selected direction.

In another aspect of the invention, the tool comprises a housing having first and second ends and a longitudinal axis extending between the first and second ends. Further, the tool has an output drive rotatably mounted on the housing for operatively engaging the mechanical fastener and a motor positioned in the housing having an output shaft. The tool also has an impact drive positioned in the housing and functionally connecting the motor and the output drive. The impact drive includes a base, an anvil shaft having an anvil extending therefrom rotatably mounted on the base, and a plurality of annular hammers. Each hammer has opposite impact lands pivotally mounted on the base for movement between three positions. The three positions include a forward position in which the respective hammer is positioned so one of said impact lands engages the anvil, a reverse position in which the respective hammer is positions so another of said impact lands engages the anvil, and a disengaged position in which neither of the impact lands engages the anvil.

In yet another aspect of the invention, the tool comprises an elongate tubular housing sized for being held in one hand and a pneumatic motor in the housing having an output shaft adapted for rotation. The tool also has an impact drive axially fixed within the housing and operatively connected to the motor output shaft. The impact drive includes a base, an anvil shaft having an anvil extending therefrom rotatably mounted on the base, and a plurality of annular hammers, each hammer having opposite impact lands pivotally mounted on the base for movement between three positions, including a forward position in which the respective hammer is positioned so one of said impact lands engages the anvil, and a reverse position in which the respective hammer is positioned so another of said impact lands engages the anvil. The respective hammer impacts the anvil on the shaft in response to loading on the impact drive exceeding a predetermined torque to instantaneously increase torque provided to the anvil shaft. Moreover, the tool has a ratchet mechanism operatively connected to the anvil shaft of the impact mechanism. The ratchet mechanism includes an output drive mounted for rotation relative to the housing for rotating a mechanical element in a selected direction.

Other objects and features will be in part apparent and in part pointed out hereinafter.

### BRIEF DESCRIPTION OF THE DRAWINGS

FIG. 1 is a perspective of a hand-held pneumatic ratchet wrench of the invention incorporating an impact drive and pneumatic motor;

FIG. 2 is an elevation of the wrench of FIG. 1 in partial section to show internal construction;

FIG. 3 is a perspective of an impact drive of the wrench;

FIG. 4 is a separated perspective of the impact drive; and

FIG. 5 is a separated perspective of a ratchet mechanism of the wrench.

Corresponding reference characters indicate corresponding parts throughout the drawings.

### DESCRIPTION OF THE PREFERRED EMBODIMENTS

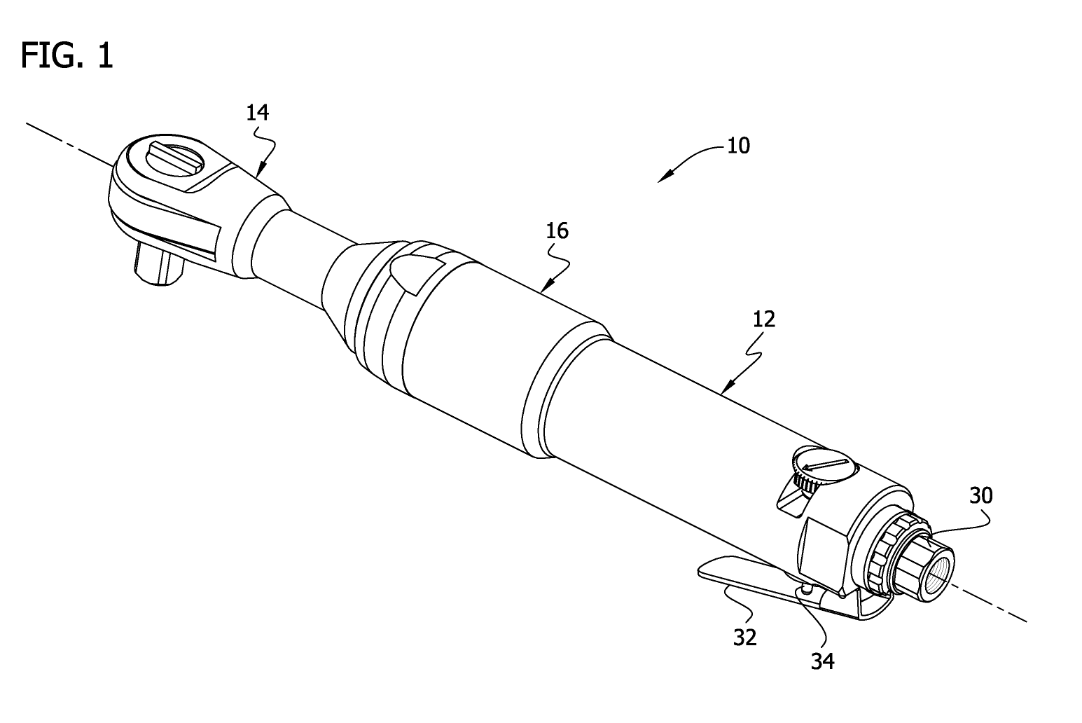

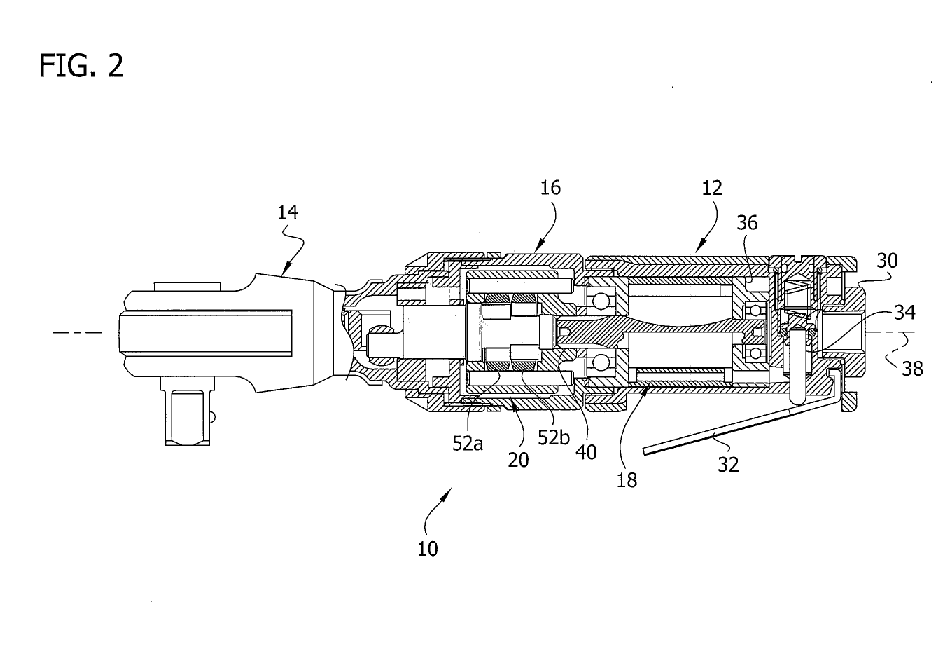

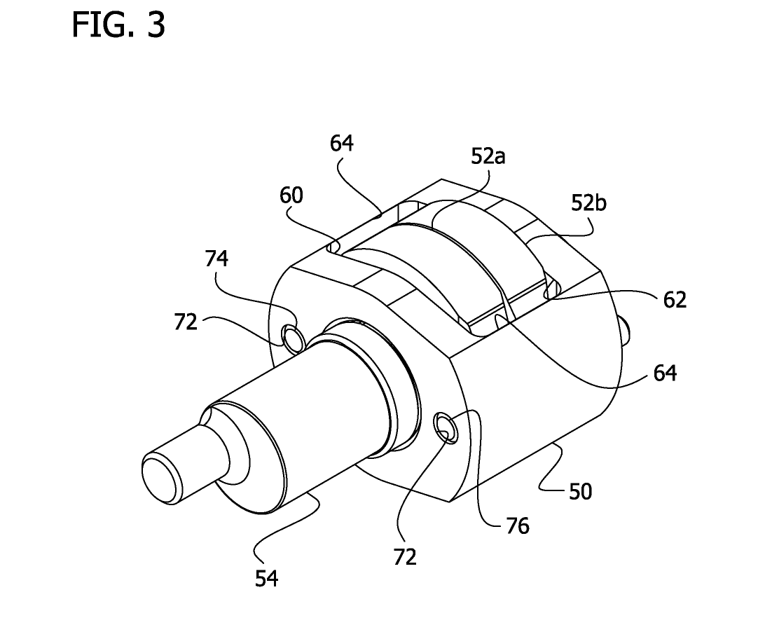

Referring now to the drawings, and particularly to FIGS. 1 and 2, a hand-held, pneumatically-driven, ratchet wrench is generally indicated at reference numeral 10. The wrench 10 includes a tubular grip, indicated generally at 12, and a head, indicated generally at 14. As shown in FIG. 2, the grip 12 and head 14 are connected by a tubular threaded coupling, generally indicated at 16, so the grip, coupling, and head form a housing that houses the functional components of the wrench 10. The grip 12 houses a motor, which is generally indicated at 18. The coupling 16 houses an impact drive, generally designated by 20 and the head 14 houses a ratchet mechanism, generally designated by 22 (FIG. 3). Each of these components will be described in greater detail below. For convenience of description, when describing orientations of components, a forward end of the wrench 10 will be understood to be at an end having the head 14 and a rearward end will be understood to be at an end having the grip 12. The motor 18 illustrated and described is a standard, air-driven motor of the type commonly used in pneumatic tools. Because the motor 18 is conventional, it will not be described in further detail.

Referring to FIG. 1, an air inlet fitting 30 provided at the rearward end of the grip 12 is capable of connecting the wrench 10 to a conventional external pressurized air source (not shown). A lever 32 provided adjacent the grip 12 controls fluid flow to the motor 18. The lever 32 is pivotally mounted on the grip 12 and is spring biased to an extended position as shown so that it can be squeezed toward the grip to open a valve 34 to selectively permit pressurized air to flow through the air inlet fitting 30 to the motor 18. As shown in FIG. 2, the motor 18 includes a rotor 36 rotatably mounted on the grip 12 for rotation about a centerline 38. The rotor 36 rotates in response to air passing through the motor 18 when the valve 34 is open. The rotor 36 includes an output shaft 40 centered on the centerline 38. Although the output shaft 40 may has other shapes without departing from the scope of the present, in one embodiment the shaft has a generally cylindrical, splined (i.e., ridged) exterior for connecting the shaft to the impact drive.

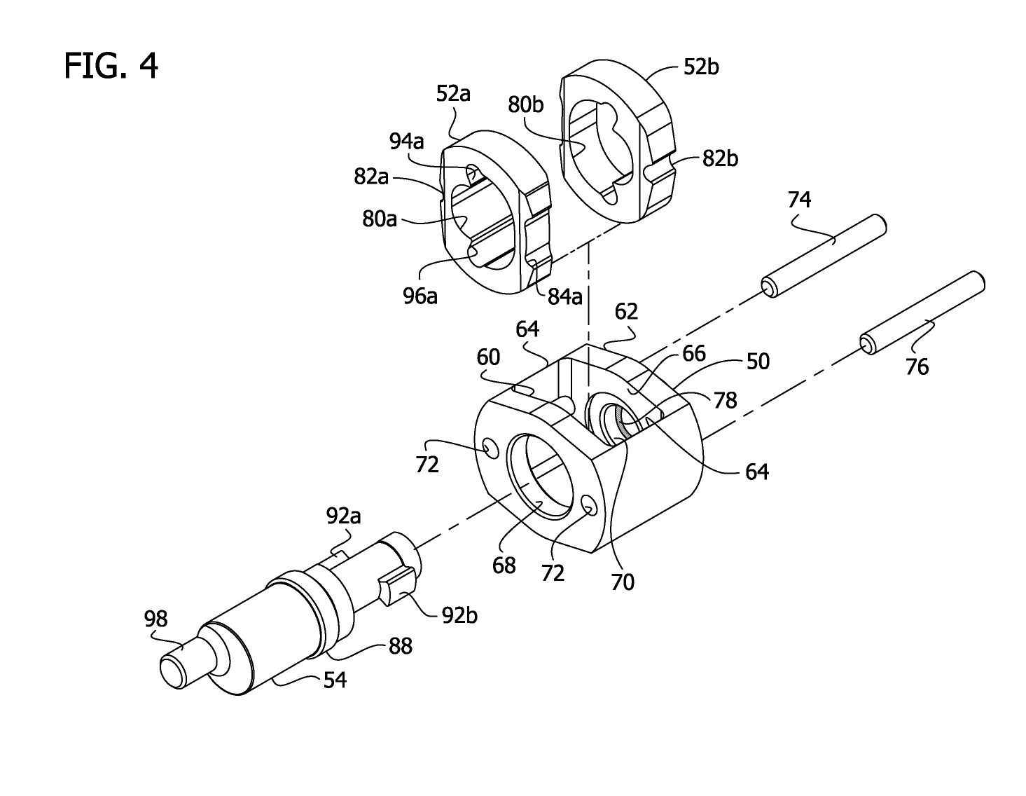

As illustrated in FIGS. 3 and 4, the impact drive 20 of the wrench 10 generally comprises a clutch base 50, a pair of hammers 52a, 52b, and an anvil shaft 54. As further illustrated in FIG. 4, the base 50 includes forward and rearward bushing plates 60, 62, respectfully, separated by integral spacers 64 creating a space 66 between the plates for receiving the hammers 52a, 52b. Each of the bushing plates 60, 62 includes a respective machined central opening 68, 70 for receiving the shaft 54. Holes 72 are provided on opposite sides of the openings 68, 70 for receiving pins 74, 76 that capture the hammers 52a, 52b in the space 66 formed between the plates 60, 62. A portion 78 of the rearward central opening is 68 splined for receiving the splined output shaft 40 of the motor 18. Thus, the base 50 turns with the motor rotor 36. Each hammer 52a, 52b includes a lobed central opening 80a, 80b, (respectively), a semi-circular slot 82a, 82b (respectively) on one side and broad slot 84a, 84b (respectively) on an opposite side. The hammers 52a, 52b are identical to each other but rotated 180° with respect to one another about the centerline 38. Thus, the slots 82a, 84b receive the pin 74 and the slots 82b, 84a receive the pin 76. The pins 74, 76 extend between the plates 60, 62 and retain the hammers 52a, 52b in the space 66. As will be appreciated by those skilled in the art, the semi-circular slot 82a and the pin 74 permit the hammer 52a to pivot about the pin 74, and the broad slot 84a and pin 76 limit rotation of the hammer 52a as it pivots on pin 74. Similarly, the semi-circular slot 82b and the pin 76 permit the hammer 52b to pivot about the pin 76, and the broad slot 84b and pin 74 limit rotation of the hammer 52b as it pivots on pin 76.

The anvil shaft 54 extends through the central openings 68, 70 of the bushing plates 60, 62 and the lobed central openings 80a, 80b of the hammers 52a, 52b. The shaft 54 also has spaced journals 88, 90 corresponding to the central openings 68, 70 in the plates 60, 62. The journals 88, 90 engage the central openings 68, 70 for supporting the shaft 54 and permitting the shaft to rotate in the base 50. Anvils 92a, 92b are provided on the shaft 54 between the journals 86, 88 so lands 94a, 94b, 96a, 96b in the lobed openings 80a, 80b of the hammers 52a, 52b (respectively) can intermittently engage the anvils to provide increased torque as will be explained in greater detail below. In addition, the shaft 54 includes a crank 98 at its forward end for driving the ratchet mechanism 22.

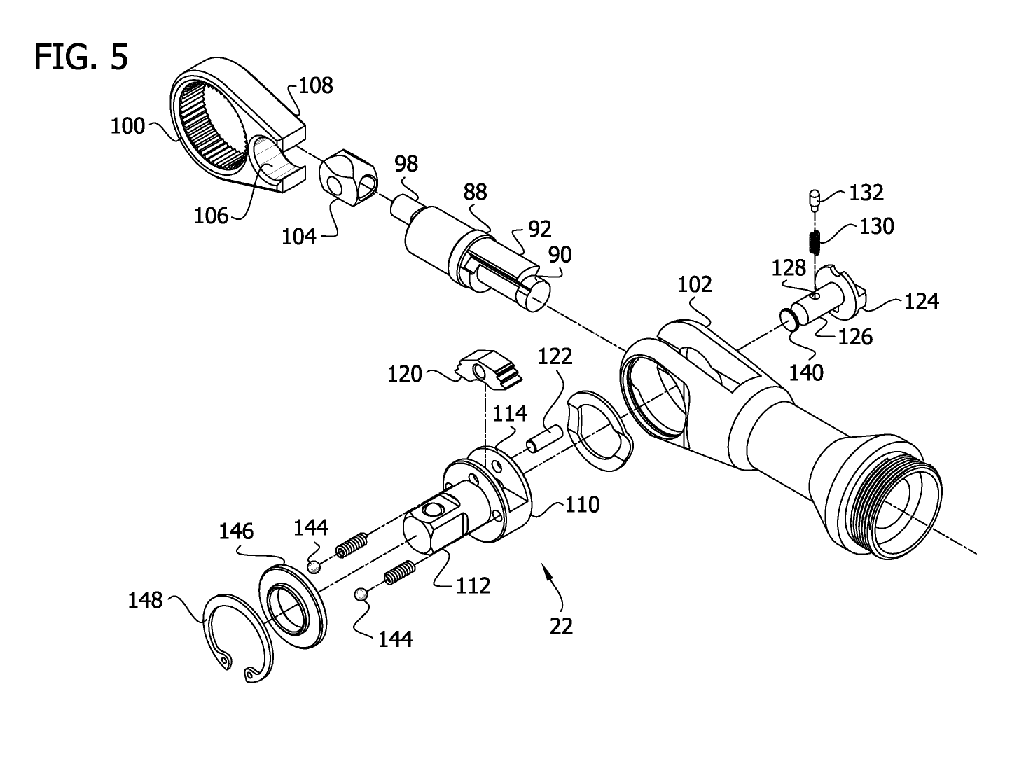

FIG. 5 illustrates the ratchet mechanism 22 of the wrench 10 which converts orbital motion of the crank 98 to rotational motion in a selected direction. The crank 98 drives an internal ring gear 100 to oscillate back and forth in a yoke 102 of the head 14. The crank 98 and ring gear 100 are operationally connected by a bushing 104 that is received in a generally cylindrical opening 106 of an arm 108 extending from the ring gear. A drive body 110 is rotatably mounted inside the ring gear 100. The drive body 110 includes square output drive 112 and a dog carrier 114. A pivotal ratchet dog or ratchet pawl 120 is pivotally captured in the dog carrier 114 by a pin 122. The dog 120 is biased to pivot in one selected direction by a selector knob 124. The selector knob 124 includes a shaft 126 that extends inside the dog carrier 114. The shaft 126 has a recess 128 that holds a spring 130 for biasing a pusher 132 against the dog 120. The pusher 132 pushes the dog 120 in a selected direction so the ring gear 100 drives the drive body 110 in one direction but not in the other direction as the ring gear oscillates back and forth. A axial bushing pad 140 is positioned between the shaft 126 of the selector knob 124 and the drive body 110, and a keeper 142 is positioned between the drive body and the yoke 102 of the head 14. Spring biased bearings 144 and a race 146 allow the drive body 110 to spin freely in the head 14. A snap ring 148 retains the race 146 in position in the head 14. The illustrated ratchet mechanism 22 is similar to that shown in U.S. Pat. No. 4,346,630, generally including an output drive 112 rotatably mounted on the head 14 for engaging a mechanical fastener. The ratchet mechanism 22 selectively limits rotation of the output drive 112 in one direction. Because the ratchet mechanism 22 is conventional, it will not be described in further detail.

In general operation of the wrench 10, air enters through the air inlet fitting 30 at the rearward end of the grip 12 when the lever 32 is squeezed toward the grip. The air enters the motor 18 where it rotates the rotor 36 including the output shaft 40. The motor shaft 36 rotates the clutch base 50. When required torque is low, the clutch base 50 turns the hammers 52a, 52b which engage the anvils 92a, 92b to turn the shaft 54. The crank 98 orbits the wrench centerline 38, oscillating the ring gear 100. As the ring gear 100 oscillates in one direction, the dog 120 pivots into the dog carrier 114 so the output drive 112 does not turn. As the gear 100 oscillates in another direction, the dog 120 engages the gear so the output drive 112 turns with the gear. When the required torque exceeds some preselected value, the hammers 52a, 52b pivot about the respective pin 74, 76, respectively, disengaging each engaged hammer land 94a and 96b, or 94b and 96a from the anvils 92a, 92b on the shaft 54 and temporarily preventing the crank 98 from driving the ratchet mechanism 22. After the anvils 92a, 92b pass the hammer lands 94a and 96b, or 94b and 96a, the respective hammer 52a, 52b pivots back to a position in which the land engages the anvils 92a, 92b on the next revolution. When the combined spinning mass of the motor rotor 36, base 60, and hammers 52a, 52b act through the hammers to impact the anvils 92a, 92b on the next revolution, an instantaneous torque increase occurs. The torque increase acts to overcome the friction in the mechanical fastener. If the torque exceeds the preselected value on the next revolution the sequence repeats. Otherwise, the impact drive 20 delivers continuous toque.

It is envisioned that the wrench of the present invention can operate at relatively high pressures thus producing relatively high rotational speeds with the motor shaft of the motor. It is therefore a benefit of this wrench 10 that the impact drive 20 is capable of handling high pressures without a speed reducing mechanism or excessively wearing components.

It is further envisioned that the wrench may have other anvil and hammer configurations without departing from the scope of the present invention. For example, it is envisioned the anvil shaft may have one anvil orbiting the shaft. In this embodiment, the anvil strikes a hammer during each half rotation of the shaft. Alternatively, it is envisioned the anvil shaft may have more than two anvils and/or the wrench may have greater numbers of hammers without departing from the scope of the present invention.

Components of the wrench of this invention are made of a suitable rigid material, such as metal (ex., cold-forged steel). But a wrench having components made of different materials does not depart from the scope of this invention.

When introducing elements of the present invention or the preferred embodiments(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above construction without departing from the scope of the invention, it is intended that all matter contained in the above description and shown in the accompanying drawings shall be interpreted as illustrative and not in a limiting sense.

What is claimed is:

1. A power driven tool for rotating a mechanical element, the tool comprising:
a housing;
a motor positioned in the housing having an output shaft extending therefrom, said shaft rotating relative to the housing during motor operation;
an impact drive axially fixed within the housing and operatively connected to the motor output shaft, the impact drive including a base, an anvil shaft having an anvil extending therefrom rotatably mounted on the base, and a plurality of annular hammers, each hammer having opposite impact lands pivotally mounted on the base for movement between three positions, including a forward position in which the respective hammer is positioned so one of said impact lands engages the anvil, a reverse position in which the respective hammer is positioned so another of said impact lands engages the anvil, and a disengaged position in which neither of the impact lands engages the anvil; and
a ratchet mechanism operatively connected to the anvil shaft of the impact mechanism, the ratchet mechanism including an output drive mounted for rotation relative to the housing for rotating a mechanical element in a selected direction.

2. A power driven tool as set forth in claim 1 wherein:
said anvil is a first anvil; and
the anvil shaft has a plurality of anvils extending therefrom including said first anvil shaft.

3. A power driven tool as set forth in claim 2 wherein the impact drive has two anvils extending from the anvil shaft and two annular hammers.

4. A power driven tool as set forth in claim 1 wherein each hammer rotates with the base in response to the rotation of the motor drive.

5. A power driven tool as set forth in claim 1 wherein each hammer is mounted on the base for pivotal movement about a corresponding axis extending parallel to a longitudinal axis of the housing.

6. A power driven tool as set forth in claim 1 wherein the motor is a pneumatic motor.

7. A power driven tool as set forth in claim 6 wherein the housing includes a head and a grip positioned opposite the head for grasping the tool to hold the tool, the grip including an air inlet fitting and a lever for controlling air flow to the motor.

8. A power driven tool for tightening and loosening a mechanical fastener, the tool comprising:
a housing having first and second ends and a longitudinal axis extending between the first and second ends;
an output drive rotatably mounted on the housing for operatively engaging the mechanical fastener;
a motor positioned in the housing having an output shaft;
an impact drive positioned in the housing and functionally connecting the motor and the output drive, the impact drive including a base, an anvil shaft having an anvil extending therefrom rotatably mounted on the base, and a plurality of annular hammers, each hammer having opposite impact lands pivotally mounted on the base for movement between three positions, including a forward position in which the respective hammer is positioned so one of said impact lands engages the anvil, a reverse position in which the respective hammer is positions so another of said impact lands engages the anvil, and a disengaged position in which neither of the impact lands engages the anvil.

9. A power driven tool as set forth in claim 8 wherein:
said anvil is a first anvil; and
the anvil shaft has a plurality of anvils extending therefrom including said first anvil shaft.

10. A power driven tool as set forth in claim 9 wherein the impact drive has two anvils extending from the anvil shaft and two annular hammers.

11. A power driven tool as set forth in claim 8 wherein each hammer is mounted on the base for pivotal movement about a corresponding axis extending parallel to a longitudinal axis of the housing.

12. A power driven tool as set forth in claim 8 wherein each hammer rotates with the base in response to the rotation of the motor.

13. A pneumatic tool for tightening and loosening a mechanical fastener, the tool comprising:
an elongate tubular housing sized for being held in one hand;
a pneumatic motor in the housing having an output shaft adapted for rotation;
an impact drive axially fixed within the housing and operatively connected to the motor output shaft, the impact drive including a base, an anvil shaft having an anvil extending therefrom rotatably mounted on the base, and a plurality of annular hammers, each hammer having opposite impact lands pivotally mounted on the base for movement between three positions, including a forward position in which the respective hammer is positioned so one of said impact lands engages the anvil, and a reverse position in which the respective hammer is positioned so another of said impact lands engages the anvil, the respective hammer impacting the anvil on the shaft in response to loading on the impact drive exceeding a predetermined torque to instantaneously increase torque provided to the anvil shaft; and
a ratchet mechanism operatively connected to the anvil shaft of the impact mechanism, the ratchet mechanism including an output drive mounted for rotation relative to the housing for rotating a mechanical element in a selected direction.

14. A pneumatic tool as set forth in claim 13 wherein:
said anvil is a first anvil; and
the anvil shaft has a plurality of anvils extending therefrom including said first anvil shaft.

15. A pneumatic tool as set forth in claim 14 wherein the impact drive has two anvils extending from the anvil shaft and two annular hammers.

16. A pneumatic tool as set forth in claim 13 wherein the anvil shaft is separately rotatably from the base.
